(19) United States
(12) Patent Application Publication
(10) Pub. No.: US 2012/0149373 A1
(43) Pub. Date: Jun. 14, 2012

(54) REDIRECTING MOBILE SERVICES IN MULTIPLE OVERLAPPED WIRELESS NETWORKS

(75) Inventors: Wei Tian, Shenzhen (CN); Dazhong Liu, Shenzhen (CN); Zhihui Zhang, Shenzhen (CN); YuanFang Yu, Shenzhen (CN); Ting Lu, Beijing (CN); Xiaowu Zhao, Shenzhen (CN); Yonggang Fang, San Diego, CA (US)

(73) Assignee: ZTE (USA) INC., Iselin, NJ (US)

(21) Appl. No.: 13/201,220

(22) PCT Filed: Feb. 11, 2010
(86) PCT No.: PCT/US10/23963

§ 371 Date: Feb. 27, 2012

Related U.S. Application Data
(60) Provisional application No. 61/151,804, filed on Feb. 11, 2009.

(51) Int. Cl. H04W 36/00

(52) U.S. Cl. 455/436

(57) ABSTRACT

Techniques, apparatuses, and systems for redirecting mobile services include generating a message with a redirection indication and transmitting the message to one or more mobile stations. A redirection indication can include an identifier for a wireless network operator and access information for a network associated with the wireless network operator.

### PRIORITY CLAIM AND CROSS REFERENCE TO RELATED APPLICATION

This document claims the benefit of the priority of U.S. Provisional Application Ser. No. 61/151,804, filed Feb. 11, 2009 and entitled “REDIRECTING MOBILE SERVICES IN MULTIPLE OVERLAPPED WIRELESS NETWORKS,” the entire contents of which are incorporated by reference as part of the disclosure of this document.

### BACKGROUND

This document relates to wireless communication systems, apparatuses, and techniques.

Wireless communication systems and apparatuses use electromagnetic waves to communicate with fixed and mobile wireless communication devices such as mobile stations, e.g., mobile devices, mobile phones, fixed wireless devices, and laptop computers with wireless communication cards, that are located within coverage areas of the wireless communication systems to provide voice and data services to mobile users.

Various wireless communication systems can include a network of one or more base stations to communicate with one or more wireless devices such as a mobile device, cell phone, wireless card, mobile station (MS), user equipment (UE), access terminal (AT), or subscriber station (SS). A base station can be referred to as an access point (AP) or access network (AN) or can be included as part of an access network or a base station subsystem (BSS). Further, a wireless communication system can include one or more core networks to control one or more base stations.

Wireless communication systems can use one or more wireless air link technologies to communicate. Various examples of wireless air link technologies include Code division Multiple Access (CDMA) such as CDMA2000 1x, High Rate Packet Data (HRPD), evolved HRPD (eHRPD), Universal Mobile Telecommunications System (UMTS), Universal Terrestrial Radio Access Network (UTRAN), evolved UTRAN (E-UTRAN), Long-Term Evolution (LTE), and Worldwide Interoperability for Microwave Access (WiMAX). Various examples of wireless technology standards bodies include 3GPP, 3GPP2, and IEEE 802.16.

### SUMMARY

This document describes, among other things, technologies for redirecting mobile services in multiple overlapped wireless networks.

In one aspect, techniques for redirecting mobile services can include generating a message with a redirection indication and transmitting the message to one or more mobile stations. The redirection indication can include an identifier for a wireless network operator and access information for a network associated with the wireless network operator. Other implementations can include corresponding systems, apparatus, and computer programs, configured to perform the actions of the techniques, encoded on computer readable mediums.

These, and other implementations, can include one or more of the following features. The identifier can include a Mobile Country Code (MCC) and a Mobile Network Code (MNC) associated with the wireless network operator. The access information can include an expected system identity associated with the wireless network operator. The access information can include an expected network identity associated with the wireless network operator. The access information can include a channel number associated with a base station of the wireless network operator. Generating the message can include generating multiple redirection indications to redirect mobile stations with different Mobile Country Code (MCC) and a Mobile Network Code (MNC) pairings to different wireless network operators. A redirection indication can include one or more Code division Multiple Access (CDMA) channel numbers associated with a respective wireless network operator.

In another aspect, a wireless communication method for redirecting a mobile station served by multiple overlapped wireless networks can include operating a wireless network to use a Mobile Country Code (MCC) and a Mobile Network Code (MNC) of a mobile station to identify a home wireless network operator for the mobile station which subscribes to the home wireless network operator; and generating a service redirection message with a redirection indication based on the MCC and MNC to direct the mobile station to be served by a wireless network operated by the home wireless network operator. Other implementations can include corresponding systems, apparatus, and computer programs, configured to perform the actions of the techniques, encoded on computer readable mediums.

These, and other implementations, can include one or more of the following features. Operating the wireless network can include operating the wireless network based on a Worldwide Interoperability for Microwave Access (WiMAX) technology. Operating the wireless network can include operating the wireless network based on a Code division Multiple Access (CDMA) technology. Operating the wireless network can include operating the wireless network based on a third Generation Partnership Project (3GPP) standard. Implementations can include generating multiple redirection indications to redirect mobile stations with different Mobile Country Code and Mobile Network Code pairings to two or more different wireless network operators, respectively.

Systems and apparatuses for wireless communication can include a base station configured to use first and second wireless communication channels to provide wireless services for first and second wireless network operators, respectively, and transmit a service redirection message over the first wireless communication channel to redirect mobile stations that are associated with the second wireless network operator to use the second wireless communication channel to acquire wireless service from the second wireless network operator. A service redirection message can include an identifier associated with the second wireless network operator.

These, and other implementations, can include one or more of the following features. A service redirection message's identifier can include a Mobile Country Code (MCC) and a Mobile Network Code (MNC) associated with the second wireless network operator. A service redirection message's identifier can include a Mobile Network Code (MNC) associated with the second wireless network operator. Implementations can include one or more mobile stations configured to receive the service redirection message, retrieve MCC and MNC values stored by the mobile station, and use, based on a comparison of the retrieved MCC and MNC values with the MCC and MNC of the service redirection message, one or more wireless communication channels specified by the service redirection message to acquire wireless service. A service redirection message can include a Code division Multiple Access (CDMA) channel number corresponding to the second wireless communication channel Implementations can include one or more mobile stations configured to receive the service redirection message, retrieve MCC and MNC values stored by the mobile station, and use, based on a comparison of the retrieved MCC and MNC values with the MCC and MNC of the service redirection message, the CDMA channel number to obtain wireless service. A service redirection message can include a system identifier associated with the second wireless network operator. A service redirection message can include a network identifier associated with the second wireless network operator. A base station can include first radio equipment associated with the first wireless network operator, and second radio equipment associated with the second wireless network operator.

In another aspect, techniques for redirecting mobile services can include generating a service redirection message with a redirection indication and transmitting the service redirection message to one or more mobile stations. A redirection indication can include an identifier for a wireless network operator and access information for a wireless network associated with the wireless network operator. An identifier for a wireless network operator can include a MCC and a MNC associated with the wireless network operator. Techniques can include enabling the one or more mobile stations to perform operations that include receiving the service redirection message; retrieving stored MCC and MNC values; and using, based on a comparison of the retrieved stored MCC and MNC values with the MCC and MNC of the service redirection message, the access information to acquire wireless service from the wireless network. An access information can include one or more wireless communication channels associated with the wireless network. Other implementations can include corresponding systems, apparatus, and computer programs, configured to perform the actions of the techniques, encoded on computer readable mediums.

Particular implementations of the subject matter described in this document can be implemented to realize one or more of the following potential advantages. A wireless network operator identifier such as a MCC and MNC pairing can uniquely identify home and roaming mobile stations without a need for using other identities. Base stations may efficiently use a broadcast overhead message to communicate a redirection. Technologies described herein can scale to redirect mobile stations to multiple operators' networks in an overlapped coverage area. Technologies described herein can be applied to Code division multiple access (CDMA) wireless networks and can extend to other networks such as 3GPP networks.

The details of one or more implementations are set forth in the accompanying attachments, the drawings, and the description below. Other features will be apparent from the description and drawings, and from the claims.

### BRIEF DESCRIPTION OF THE DRAWINGS

FIG. 1A shows an example of a base station redirecting a mobile station.

FIG. 1B shows an example of multiple wireless communication networks that overlap.

FIG. 2 shows an example of a radio station architecture.

FIG. 3 shows an example of a service redirection message.

FIG. 4 shows an example of a service redirection record.

FIG. 5 shows a different example of a service redirection record.

FIG. 6 shows an example of base station operations to redirect mobile stations.

FIG. 7 shows an example of mobile station operations based on a service redirection message.

Like reference symbols in the various drawings indicate like elements.

### DETAILED DESCRIPTION

Wireless networks of multiple wireless network operators can overlap. In some cases, wireless network operators build their own infrastructures. In some cases, wireless network operators share base station equipment such as a radio access network (RAN). For example, two or more wireless network operators such as a mobile virtual network operator (MVNO) or a mobile network operator (MNO) can operate the same base station to provide wireless service.

Multiple wireless network operators can share base station subsystem (BSS) infrastructures and cell sites, where each operator has its own radio frequency and core network. In an overlapped coverage area served by multiple wireless network operators, operators may prefer to have their subscribers served through their own networks, not through other operators' networks even if they have one or more roaming agreements in place that support roaming services. Additionally, subscribers, e.g., users of a mobile station, may prefer to be served through their home operator's network to avoid roaming charges.

A wireless network operator may bring on-line, tune, or optimize a wireless network in an area where multiple operators' networks overlap. If a mobile station roams on to a wireless network that is not ready for service, the mobile station may not receive service. The wireless network operator may exclude mobile stations from a wireless network that is not ready for service, while including keeping test mobile stations on the wireless network for testing purposes. Here, the wireless network operator prefers to not provide services to foreign mobile stations that are attempting to roam into the operator's test network.

Thus, wireless network operators may prefer to redirect mobile stations to other wireless networks. Some approaches to address this problem such as broadcasting system identification (SID) and network Identification (NID) values for each mobile station to match them to a mobile station's home SID and NID values for a service redirection may not be efficient or appropriate. Each wireless network operator can have multiple SIDs and NIDs in the operator's networks based on how the networks are configured. Mobile stations subscribed to the same wireless network operator may belong to different home networks that have different SID and NID values. It may not be feasible or possible for an operator to know all of the SID and NID values associated with other operators' networks, therefore, it may be difficult to use SID and NID values to redirect mobile stations. Further, assuming an operator can obtain all of the SID and NID values of the other operators that are to be redirected, broadcasting such a list of SID and NID values may require increased overhead and bandwidth usage.

This document includes descriptions of technologies to selectively redirect mobile stations. For example, in areas where multiple wireless service areas overlap, one or more of the described technologies can selectively redirect mobile stations from one wireless network in the overlap area to a different wireless network operating in the overlap area. One or more of the described technologies can use a wireless network operator identifier to redirect mobile stations that are associated with the wireless network operator identifier. Using a wireless network operator identifier such as a Mobile Country Code (MCC) and a Mobile Network Code (MNC) pairing can redirect mobile stations that are subscribed to a specific wireless network operator, regardless of whether the subscribed mobile stations have different SID and NID values.

Redirecting mobile services can include generating a message with a redirection indication and transmitting the message to one or more mobile stations. A redirection indication can include an indicator, e.g., an identifier, for a wireless network operator and access information for a network associated with the wireless network operator. For example, a wireless communication method for redirecting a mobile station served by multiple overlapped wireless networks can include operating a wireless network to use a MCC and a MNC of a mobile station to identify a home wireless network operator for the mobile station which subscribes to the home wireless network. The wireless communication method can include generating a service redirection message with a redirection indication based on the MCC and MNC to direct the mobile station to be served by its home wireless network.

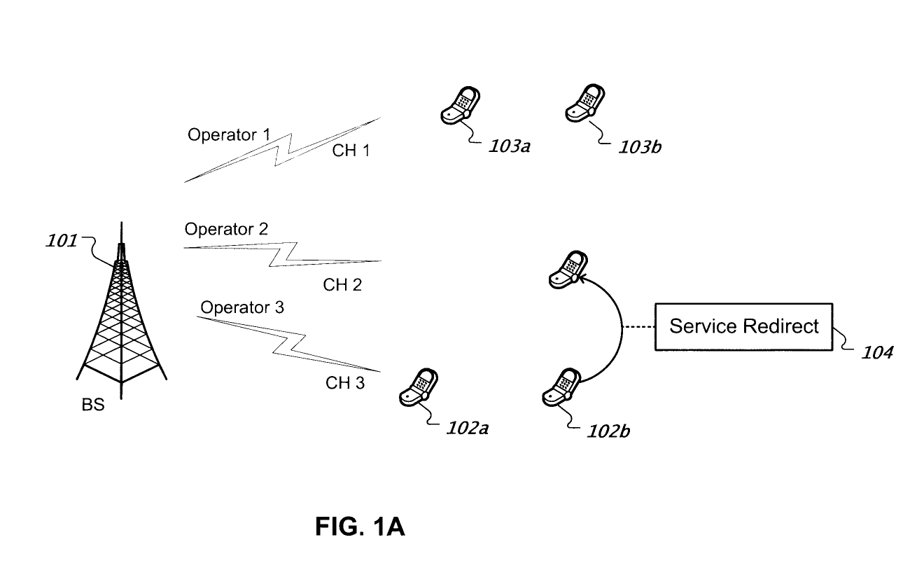

FIG. 1A shows an example of a base station redirecting a mobile station. A base station 101 operates multiple overlapping wireless communication networks. The base station 101 uses multiple wireless communication channels to provide wireless services for multiple wireless network operators. In this example, wireless channel one (CH1), wireless channel two (CH2), and wireless channel three (CH3) are associated with respective first, second, and third wireless network operators. In some implementations, the base station 101 includes radio equipment for each affiliated wireless network operator. For example, a base station can include transmitter and receiver units for each of the affiliated wireless network operators.

The base station 101 can send a service redirection message 104 over a wireless communication channel to selectively redirect mobile stations to one or more different wireless network operators. In this example, mobile stations 102a, 102b search for wireless services on CH3. The mobile stations 102a, 102b receive the service redirection message 104 on CH3, whereas mobile stations 103a, 103b that are on a different wireless communication channel do not receive the message 104.

The mobile stations 102a, 102b that receive the service redirection message 104 process the message to determine whether a redirection is required. The message 104 includes an identifier of a wireless network operator whose mobile stations are required to be redirected to a different wireless communication channel. A mobile station 102b whose wireless network operator is identified in the message 104 can use a wireless communication channel identifier included in the message 104 to acquire wireless service on a corresponding channel. A mobile station 102a whose wireless network operator is not identified in the message 104 is not required to be redirected and can remain on the wireless communication channel.

FIG. 1B shows an example of multiple wireless communication networks that overlap. A wireless communication network can include a one or more components such as a base station (BS) 110a, 110b, 110c, 110d. Different wireless operators can operate different wireless networks that overlap. For example, different wireless operators can operate different base stations BS1, BS2, BS3, and BS4. In some cases, such base stations BS1, BS2, BS3, and BS4 can be located in one physical structure such as an equipment room. An Overlap area 120 represents the overlapping coverage area produced by base stations BS1, BS2, BS3, and BS4. Mobile stations 105a, 105b within the overlap area 120 may receive signals from base stations BS1, BS2, BS3, and BS4 and can establish communications with any one of them. However, a mobile station 105a, 105b may acquire service with a base station that is not apart of the mobile station's home network, and therefore, may have to pay roaming charges or may not receive service.

One or more of the base stations BS1, BS2, BS3, and BS4 can send service redirection messages that identify a wireless network operator and one or more associated wireless communication channels. A mobile station 105a, 105b that receives a service redirection message can process the message to determine whether a redirection to a channel specified by the message is requested.

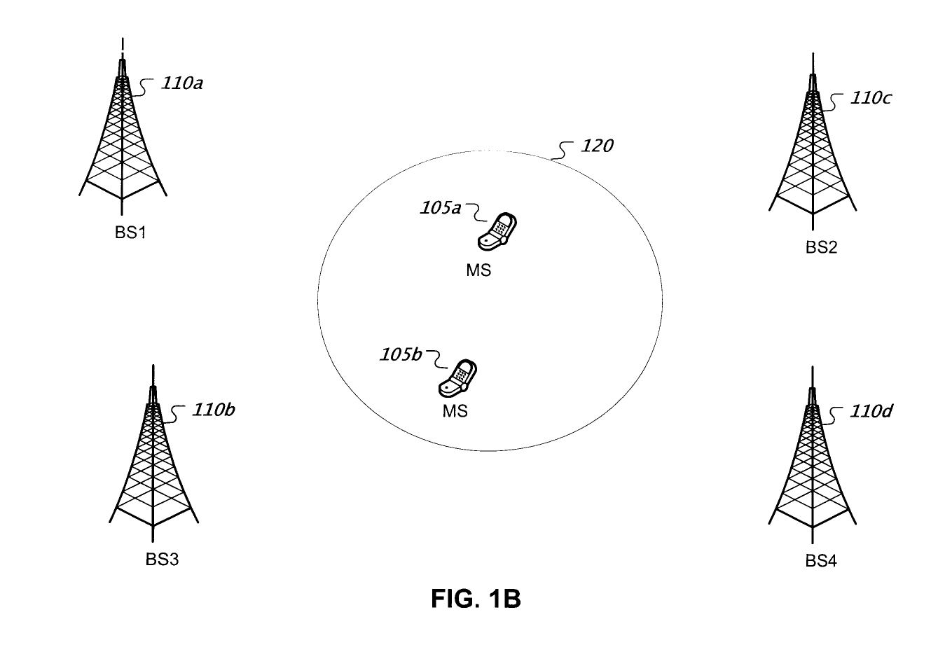

FIG. 2 shows an example of a radio station architecture. A radio station 205, such as a mobile station or a base station, can include processor electronics 210 such as a microprocessor that implements one or more of the techniques presented in this document. The radio station 205 can include transceiver electronics 215 to send and receive wireless signals over one or more communication interfaces such as an antenna 220. The radio station 205 can include other communication interfaces for transmitting and receiving data.

A mobile station can access an identity module device such as a Subscriber Identity Module (SIM) card or a Removable User Identity Module (RUIM) card to retrieve a subscriber identity such as an International Mobile Subscriber Identity (IMSI) or portions thereof. In some implementations, a mobile station can include an identity module device. In some implementations, a mobile station can include a slot for an insertable identity module device. In some implementations, a mobile station includes a memory configured to store a subscriber identity.

Service redirection techniques can include using a wireless network operator identifier. A service redirection message can specify an identifier of a wireless network operator to redirect associated mobile stations to a different wireless network. In various wireless networks, a mobile station uses a subscriber identity to communicate with wireless networks. A subscriber identity can include a wireless network operator identifier. Mobile stations can process service redirection messages using a stored wireless network operator identifier.

Information included in a mobile station's subscriber identity can be used to match a stored wireless network operator identifier to one or more identifiers in a service redirection message. A subscriber identity, such as an IMSI, can include a MCC, a MNC, and a mobile station identification number (MSIN). A MCC and MNC can identify a wireless network operator uniquely in the world. In some implementations, a wireless network operator identifier includes MCC and MNC values. The MNC can include two or three digits. Together, the MCC and the MNC pair are the first 5 to 6 digits of a mobile station's IMSI. In some implementations, a mobile station is configured to a access a device such as an identity module or a memory to retrieve MCC and MNC values, e.g., one or more portions of a stored IMSI. Based on the retrieved values, the mobile station can match them against a service redirection message to determine whether a redirection is required.

Service redirections techniques can include communicating a service redirection message. A base station or a core network associated with the base station can use MCC and MNC pairs to uniquely identify mobile stations to be redirected. A base station can broadcast a service redirection message to multiple mobile stations. A service redirection message can be used to redirect roaming mobile stations to their home networks. A service redirection message can keep home mobile stations in their network.

A service redirection message can include one or more redirection indications, e.g., a redirection record, to perform one or more redirections, respectively. For example, different records can redirect to different wireless network operators. A mobile station can iteratively process the records to determine if a redirection record is intended for the mobile station.

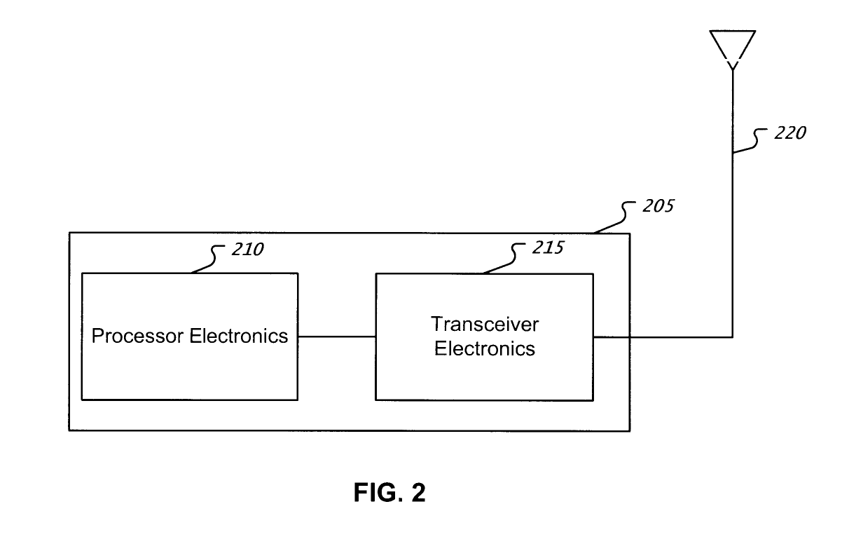

FIG. 3 shows an example of a service redirection message. A service redirection message 305 can include a base station identifier field 310, a sequence number field 315, a record count field 320, and one or more service redirection records 325. A value in the record count field 320 indicates the number of service redirection records that are included in the service redirection message 305. A base station that generates the service redirection message 305 can include the base station's pilot PN sequence offset in the base station identifier field 310. In some implementations, the base station can set the sequence number field 315 to indicate that the message 305 is a service redirection message.

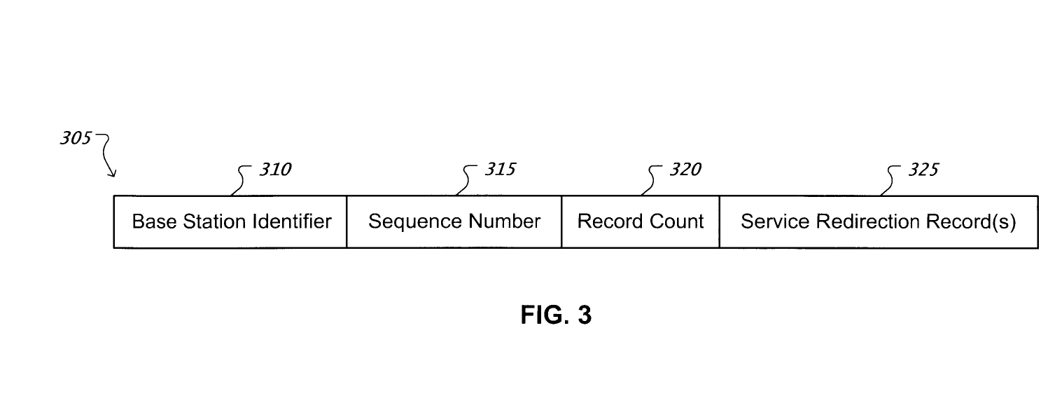

FIG. 4 shows an example of a service redirection record. A service redirection record 405 can include a wireless network operator identifier 410 and a wireless communication channel identifier 415. A base station can include a wireless network operator identifier 410 in a service redirection record 405 to control mobile stations that are associated with the wireless network operator identifier 410 to acquire wireless services on a channel identified by the wireless communication channel identifier 415.

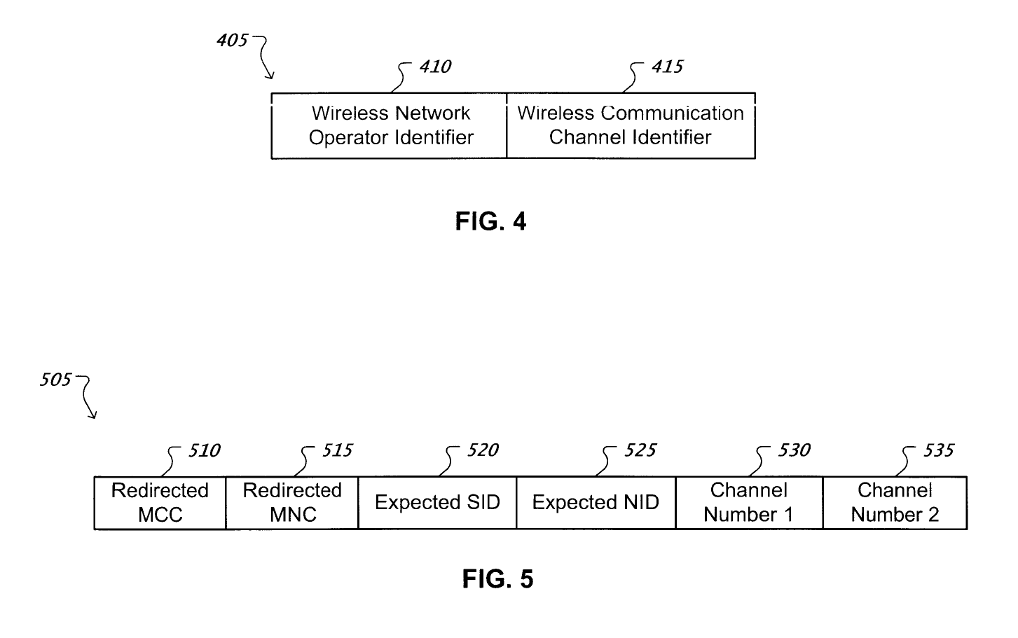

FIG. 5 shows a different example of a service redirection record. A service redirection record 505 can include a redirected MCC 510, redirected MNC 515, expected SID 520, expected NID 525, and one or more channel numbers 530, 535. Based on the service redirection record 405, a mobile station that is associated with the MCC and MNC indicated in the redirected MCC 510 and redirected MNC 515 fields, respectively, searches for wireless service associated with the expected SID 520 and the expected NID 525 on the one or more channel numbers 530, 535 included in the service redirection record 405.

Universal Service Redirect Message (USRM) and General Service Redirect Message (GSRM) are examples of a service redirection message. In some implementations, a USRM contains a tag section that includes a base station identifier field such as a 9-bit PILOT_PN field, a configuration message sequence number field such as a 6-bit CONFIG_MSG_SEQ field, and a redirection record number field such as a 4-bit NUM_REDIR_REC field. A PILOT_PN is a pilot PN sequence offset index. For example, a base station that transmits a service redirection message can includes the base station's pilot PN sequence offset in the PILOT_PN field of the message. A PILOT_PN field can be in units of 64 PN chips. The base station can set CONFIG_MSG_SEQ to a configuration sequence value such as CONFIG_SEQ.

A USRM can include one or more service redirection records. A USRM's service redirection record can include a redirected wireless operator identifier portion that includes a Redirected Mobile Country Code (REDIRECTED_MCC) field and a Redirected Mobile Network Code (REDIRECTED_MNC) field. A base station can set the REDIRECTED_MCC field to the MCC of the mobile stations to be redirected. The base station can set the REDIRECTED_MNC field to the MNC of the mobile stations to be redirected. In some implementations, a service redirection record can include a band class field. A base station, such as a CDMA based base station, can set a band class field to a CDMA band class.

When a mobile station receives a USRM, the mobile station can compare the fields of REDIRECTED_MCC and REDIRECTED_MNC with the mobile station's stored MCC and MNC values. If the MCC and MNC values match, the mobile station can switch to a wireless network indicated by the USRM message. A USRM's service redirection record can include EXPECTED_SID, EXPECTED_NID, and one or more CDMA_CHAN values. A USRM's service redirection record can indicate the number of included CDMA_CHAN value(s). A mobile station can switch to the wireless network associated with the EXPECTED_SID, EXPECTED_NID, and CDMA_CHAN values.

A USRM's EXPECTED_SID field includes an expected SID value. If a base station is redirecting the mobile station to a specific system, the base station can set this field to the SID of that system; otherwise, the base station can set this field to ‘0’.

A USRM's EXPECTED_NID field includes an expected NID value. If a base station is redirecting the mobile station to a specific network, the base station can set this field to the NID of that network; otherwise, the base station can set this field to 65535.

A USRM's CDMA_CHAN field can include a CDMA channel number. A base station can include a CDMA channel number field specifying an associated CDMA channel for each CDMA channel that a redirected mobile station should attempt to acquire CDMA based wireless services.

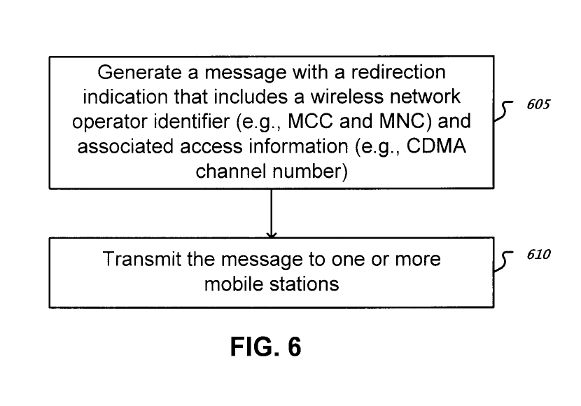

FIG. 6 shows an example of base station operations to redirect mobile stations. A base station can generate a message with a redirection indication that includes a wireless network operator identifier, e.g., a MCC and MNC value pairing, and associated access information, e.g., a CDMA channel number (605). In some implementations, access information can include an expected system identity associated with the wireless network operator. The access information can include an expected network identity associated with the wireless network operator. The access information can include a channel number associated with a base station of the wireless network operator. Generating the message can include generating multiple redirection indications to redirect mobile stations with different Mobile Country Code (MCC) and a Mobile Network Code (MNC) pairings to different wireless network operators. The base station can transmit the message to one or more mobile stations (610).

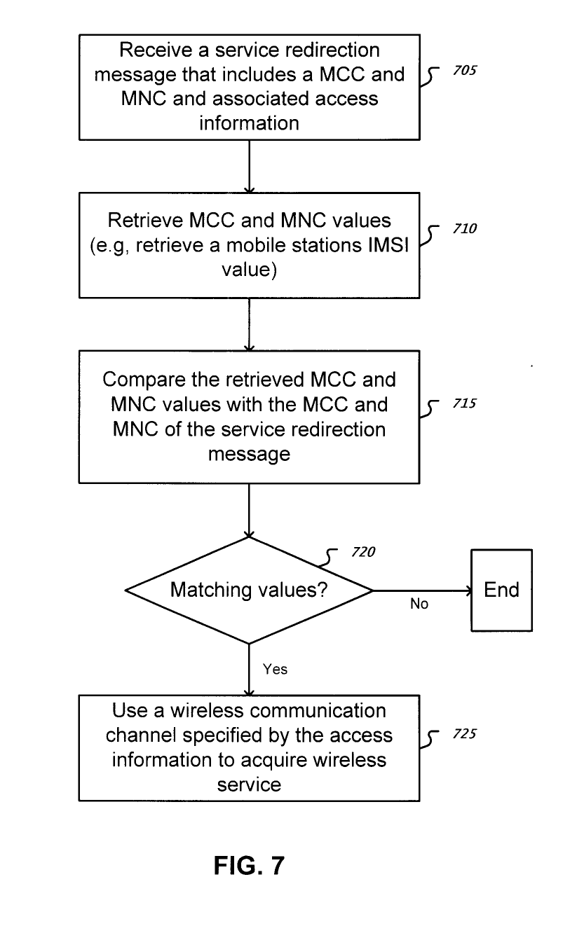

FIG. 7 shows an example of mobile station operations based on a service redirection message. A mobile station can receive a service redirection message that includes a MCC and MNC and associated access information (705). The mobile station can retrieve MCC and MNC values (710). In some implementations, a mobile station can access the mobile station's IMSI value to retrieve MCC and MNC values. In some implementations, a mobile station can access an identity module to retrieve the MCC and MNC values. The mobile station can compare the retrieved MCC and MNC values with the MCC and MNC of the service redirection message (715).

If the mobile station's retrieved MCC and MNC values do not match the MCC and MNC values included in the service redirection message (720), then the mobile station is not required to be redirect. However, a service redirection message can include two or more redirection records, each with different MCC and MNC pairs. A mobile station can proceed to process an additional redirection record in a service redirection message to determine whether a redirection is required. If the mobile station's retrieved MCC and MNC values do match the MCC and MNC values included in the service redirection message (720), then the mobile station can use a wireless communication channel specified by the access information to acquire wireless service (725). In some implementations, regardless of whether the values match (720), the mobile station periodically listens for additional service redirection messages. If the mobile station receives an additional message, the operations depicted by FIG. 7 can be repeated.

The disclosed and other embodiments and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for wireless communications, comprising:
generating a message with a redirection indication, wherein the redirection indication comprises an identifier for a wireless network operator and access information for a network associated with the wireless network operator; and
transmitting the message to one or more mobile stations.

2. The method of claim 1, wherein the identifier comprises a Mobile Country Code (MCC) and a Mobile Network Code (MNC) associated with the wireless network operator.

3. The method of claim 2, comprising:
operating a mobile station to receive the message, retrieve MCC and MNC values stored by the mobile station, and use, based on a comparison of the retrieved MCC and MNC values with the MCC and MNC of the message, one or more wireless communication channels specified by the message to acquire wireless service.

4. The method of claim 1, wherein generating the message comprises generating two or more redirection indications to redirect mobile stations with different Mobile Country Code (MCC) and Mobile Network Code (MNC) pairings to different wireless network operators.

5. The method of claim 4, wherein the two or more redirection indications each include one or more Code division Multiple Access (CDMA) channel numbers associated with a respective wireless network operator.

6. The method of claim 1, wherein the access information comprises an expected system identifier associated with the wireless network operator.

7. The method of claim 1, wherein the access information comprises an expected network identifier associated with the wireless network operator.

8. The method of claim 1, wherein the access information comprises a channel number associated with a base station of the wireless network operator.

9. The method of claim 1, wherein generating the message comprises including, in the access information, one or more Code division Multiple Access (CDMA) channel numbers associated with the wireless network operator.

10. A method for wireless communications, comprising:
operating a wireless network to use a Mobile Country Code (MCC) and a Mobile Network Code (MNC) of a mobile station to identify a home wireless network operator for the mobile station which subscribes to the home wireless network operator; and
generating a service redirection message with a redirection indication based on the MCC and MNC to direct the mobile station to be served by a wireless network operated by the home wireless network operator.

11. The method of claim 10, wherein operating the wireless network comprises operating the wireless network based on a Worldwide Interoperability for Microwave Access (WiMAX) technology.

12. The method of claim 10, wherein operating the wireless network comprises operating the wireless network based on a Code Division Multiple Access (CDMA) technology.

13. The method of claim 10, wherein operating the wireless network comprises operating the wireless network based on a third Generation Partnership Project (3GPP) standard.

14. The method of claim 10, comprising:
generating multiple redirection indications to redirect mobile stations with different Mobile Country Code and Mobile Network Code pairings to two or more different wireless network operators, respectively.

15. A system for wireless communications, comprising:
a base station configured to use first and second wireless communication channels to provide wireless services for first and second wireless network operators, respectively, and transmit a service redirection message over the first wireless communication channel to redirect mobile stations that are associated with the second wireless network operator to use the second wireless communication channel to acquire wireless service from the second wireless network operator, wherein the service redirection message comprises an identifier associated with the second wireless network operator.

16. The system of claim 15, wherein the identifier comprises a Mobile Country Code (MCC) and a Mobile Network Code (MNC) associated with the second wireless network operator.

17. The system of claim 16, comprising:
a mobile station configured to receive the service redirection message, retrieve MCC and MNC values stored by the mobile station, and use, based on a comparison of the retrieved MCC and MNC values with the MCC and MNC of the service redirection message, one or more wireless communication channels specified by the service redirection message to acquire wireless service.

18. The system of claim 16, wherein the service redirection message comprises a Code Division Multiple Access (CDMA) channel number corresponding to the second wireless communication channel.

19. The system of claim 16, comprising:
a mobile station configured to receive the service redirection message, retrieve MCC and MNC values stored by the mobile station, and use, based on a comparison of the retrieved MCC and MNC values with the MCC and MNC of the service redirection message, the CDMA channel number to obtain wireless service.

20. The system of claim 15, wherein the service redirection message comprises a system identifier associated with the second wireless network operator.

21. The system of claim 15, wherein the service redirection message comprises a network identifier associated with the second wireless network operator.

22. The system of claim 15, wherein the base station comprises first radio equipment associated with the first wireless network operator, and second radio equipment associated with the second wireless network operator.

23. A method for wireless communications, comprising:
generating a service redirection message with a redirection indication, wherein the redirection indication comprises an identifier for a wireless network operator and access information for a wireless network associated with the wireless network operator, wherein the identifier comprises a Mobile Country Code (MCC) and a Mobile Network Code (MNC) associated with the wireless network operator;
transmitting the service redirection message to one or more mobile stations; and
enabling the one or more mobile stations to perform operations that comprise:
receiving the service redirection message;
retrieving stored MCC and MNC values; and
using, based on a comparison of the retrieved stored MCC and MNC values with the MCC and MNC of the service redirection message, the access information to acquire wireless service from the wireless network, wherein the access information includes one or more wireless communication channels associated with the wireless network.

24. The method of claim 23, wherein generating the service redirection message comprises:
generating multiple redirection indications to redirect mobile stations with different MCC and MNC values to two or more different wireless network operators, respectively.

25. The method of claim 23, wherein the access information comprises a Code Division Multiple Access (CDMA) channel number corresponding to the wireless network.
